(19) United States
(12) Patent Application Publication
(10) Pub. No.: US 2010/0052328 A1
(43) Pub. Date: Mar. 4, 2010

(54) HYBRID WIND TURBINE - COMBUSTION ENGINE ELECTRICAL POWER GENERATOR

(75) Inventor: Alexander J. Pavlak, Severna Park, MD (US)

Correspondence Address: LAUBSCHER & LAUBSCHER, P.C., 1160 SPA ROAD, SUITE 2B, ANNAPOLIS, MD, 21403, US

(73) Assignee: THALES RESEARCH, INC., Severna Park, MD (US)

(21) Appl. No.: 12/201,331

(22) Filed: Aug. 29, 2008

(51) Int. Cl. F03D 9/00

(52) U.S. Cl. 290/55

(57) ABSTRACT

A hybrid power generator is characterized by the combination of a wind turbine and a combustion engine to drive a generator. The wind turbine and combustion engine are each connected with the generator via a drive train. Each drive train preferably includes a gearbox and a clutch, with the clutches being operated by a controller to determine which of the wind turbine and combustion engine are connected with the generator. Preferably, under high wind conditions, only the wind turbine is connected with the generator to produce electricity for delivery to a power grid via a converter. During periods of peak demand and low or no wind conditions, the combustion engine is connected with the generator. It is also possible to connect the wind turbine and combustion engine with the generator at the same time. Also, a differential at the input to the generator can compensate for the different rotary speed outputs from the wind turbine and the combustion engine.

### BACKGROUND OF THE INVENTION

The present invention relates to an improved hybrid electrical power generator for use by electric utilities.

Wind turbine generators are a known source of electrical power. However, the major drawback of wind turbine generators is that they do not generate any power when there is insufficient wind. Because the wind is intermittent and uncontrollable, wind turbine generators can not be relied upon to provide a continuous source of electrical power.

Intermittent wind is a pernicious problem for wind energy because wind farms cannot be relied upon to produce rated power during peak demand. In fact, wind energy at many wind turbine generator sites is negatively correlated with peak demand. As a result, the electrical grid requires the same number of conventional generators with or without wind because conventional generators must carry full load during peak demand. While wind turbine generators save fuel, they do not reduce the capital carrying costs of conventional infrastructure. In a marketplace that correctly accounts for cost, wind energy competes with the cost of fuel, but not with the wholesale price of electricity.

The real cost of compensating for intermittency will be determined when wind power penetration becomes a significant percentage of total electrical grid supply. Eventually, savvy customers will reward wind power vendors for delivering energy on demand as required by consumers.

### BRIEF DESCRIPTION OF THE PRIOR ART

The wind energy industry is aware of the wind intermittency problem. Most efforts to provide a more stable power source have involved some form of storage including electrolysis and hydrogen storage as disclosed in U.S. Pat. Nos. 7,396,440 and 7,177,482, pumped hydro storage as disclosed in U.S. Pat. No. 7,239,035, superconducting magnetic storage as disclosed in U.S. Pat. No. 7,397,142, compressed air storage as disclosed in US patent application publication No. 2008/0050234, and flywheels as described in U.S. Pat. No. 6,748,737. It is difficult for storage solutions to be cost effective because the quantity of stored energy is large and cycling frequency is low.

The Appa U.S. Pat. No. 6,492,743 discloses a hybrid wind turbine wherein combustible jets are installed at the tips of the turbine blades to keep the blades rotating and aid in generating power during low wind. The Jaunich U.S. Pat. No. 6,605,880 recognizes the system cost of wind intermittency and the need to coordinate a wind turbine with a conventional generator to provide a utility with a reliable source of electric power. Jaunich uses a wind turbine as a primary generator along with a secondary source, such as a conventional ground mounted natural gas turbine generator set. The electric power from both generators is delivered to the utility in a coordinated manner. While Jaunich is directed to coordinating two separate and complete generator sets, it does not contemplate a hybrid wind turbine-combustion engine power source using a single electrical generator.

### SUMMARY OF THE INVENTION

The present invention relates to a hybrid electrical generator set. It includes a conventional electrical generator that converts mechanical energy into electrical energy. The electrical generator is mechanically driven by a wind turbine, or a combustion engine, or both the wind turbine and the engine at the same time.

The wind turbine-combustion engine hybrid generator according to the invention provides power on demand, even if there is no wind. Power on demand overcomes intermittency which is a serious limitation of conventional wind turbines.

The wind turbine-combustion engine hybrid generator is a lower cost solution than a wind turbine generator set plus a separate combustion engine generator set. The hybrid generator reduces cost by using a single electrical generator, single power conditioning electronics, transformers and switchgear, and a single housing and mounting structure.

### BRIEF DESCRIPTION OF THE FIGURES

FIG. 1 is a block diagram of a conventional wind turbine according to the prior art;

FIG. 2 is a block diagram of the wind turbine-combustion engine according to a first embodiment of the invention;

FIG. 3 is a block diagram of the wind turbine-combustion engine according to a second embodiment of the invention; and

FIGS. 4 and 5 show different drive trains, respectively, for the wind turbine-combustion engine according to the invention.

### DETAILED DESCRIPTION

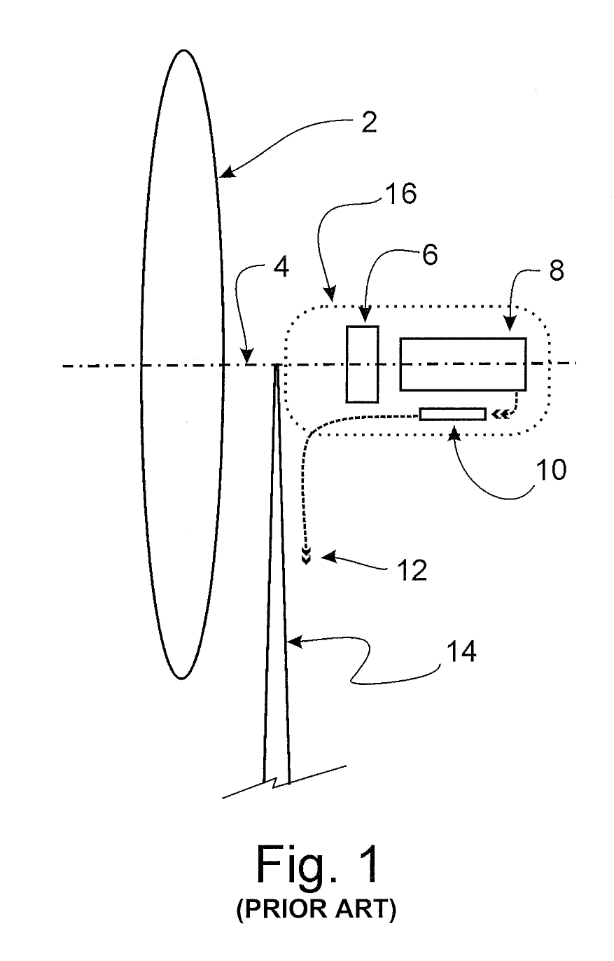

Referring first to FIG. 1, a conventional wind turbine generator according to the prior art will be described. The conventional wind turbine generator includes a wind turbine having rotor blades, schematically illustrated as a disk 2 which are connected with a shaft 4. As wind strikes the blades, they rotate the shaft, thereby producing a rotary output. The shaft is connected with a drive train 6 which increases the speed of the rotary output to drive the input of an electrical generator 8. The generator output is delivered to a converter 10 which converts the electrical current to a format for interfacing with the electric current on an electrical power grid 12. The generator is typically an asynchronous induction generator. A power converter 10 is often used to convert this output to constant frequency and voltage to interface with the electric grid. US patent application publication No. 2008/015738 A1 describes a method for coordinating this conversion for multiple wind turbines.

As is known in the art, the wind turbine can be mounted on a pole or mast 14 so that the rotor blades are elevated from the ground to catch the wind. The drive train 6, generator 8 and converter 10 are preferably arranged in a housing 16 which is also mounted on the mast 14 and connected with the shaft 4 from the turbine. Power transformers and switchgear (not shown) are mounted on the ground at a wind farm site.

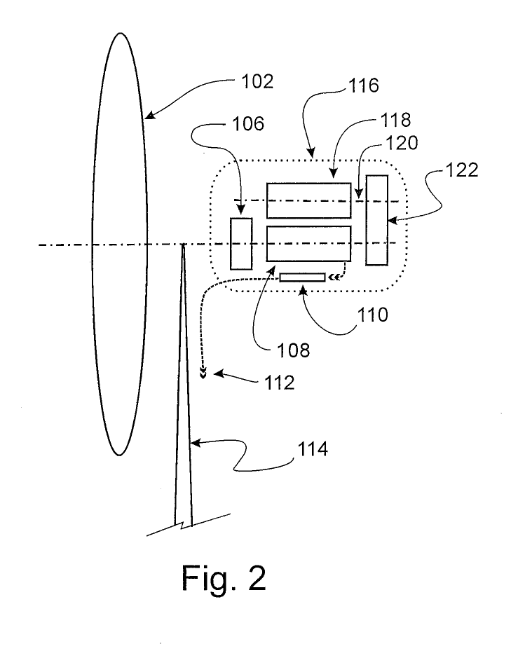

The hybrid wind turbine-combustion engine electrical power generator according to the invention will be described with reference to FIG. 2. The power generator includes a wind turbine having multiple rotor blades schematically illustrated as a disk 102 which are connected with a shaft 104. As wind strikes the blades, they rotate the shaft, thereby producing a rotary output. The shaft is connected with a drive train 106 which increases the speed of the rotary output to drive the input of an electrical generator 108 which is preferably an asynchronous induction generator. As the cage rotor turns, an alternating electrical current is generated in the stator poles to produce an electric current output from the generator. The output is delivered to a converter 110 which converts the electrical current to a format for interfacing with the electric current on an electrical power grid 112. The wind turbine is mounted on a mast 114 so that the rotor blades are elevated from the ground to catch the wind. The drive train 106, generator 108 and converter 110 are arranged in a housing 116 which is also mounted on the mast 114 and connected with the shaft 104 from the turbine. Power transformers and switchgear (not shown) are mounted on the ground at a wind farm site.

The power generator of the invention further includes a combustion engine 118 having an output shaft 120 connected with a drive train 122 which in turn is connected with the generator 108. The engine 118 can be an internal combustion engine or a gas turbine and is fueled by several different chemical sources such as oil, natural gas or hydrogen. A preferred engine is a natural gas fueled turbine as used in conventional peak load generators. The preferred size for the combustion engine and the wind turbine is for each to have the same power rating as the electrical generator. Thus, either the combustion engine or the wind turbine could drive the generator at full rated capacity. An alternative is to use a smaller combustion engine to realize many of the advantages of the hybrid but at a reduced cost.

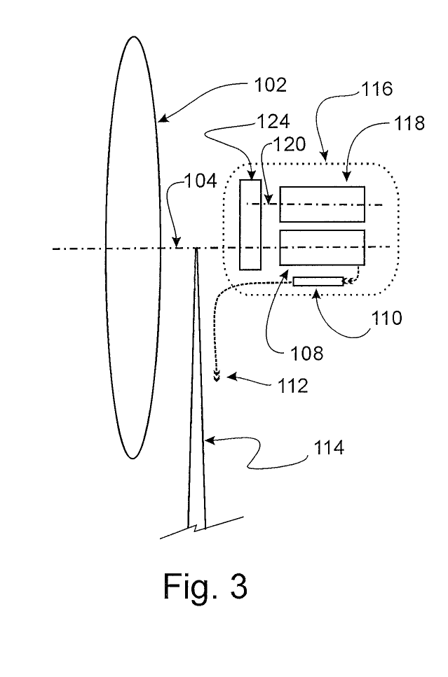

In FIG. 3 is shown an alternate embodiment of the invention wherein a single drive train 124 is connected with the outputs of both the wind turbine 102 and the combustion engine 118 to adjust the rotary speed of each to suit the generator 108.

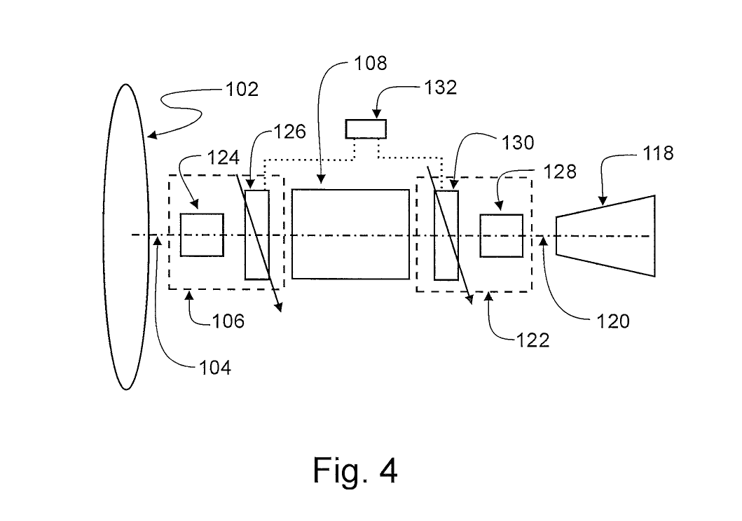

FIG. 4 is a schematic view of the invention of FIG. 2 showing the drive trains 106 and 122 in more detail. More particularly, the drive train 106 includes a gearbox 124 connected with the drive shaft 104 of the turbine 102 and may include a clutch 126 connected with the gearbox. Similarly, the drive train 122 includes a gearbox 128 connected with the drive shaft 120 of the combustion engine 118 and may include a clutch 130 connected with the gearbox. The gearboxes 124, 128 increase the shaft rotation from the turbine and combustion engine, respectively and the clutches 126, 130 allow the wind turbine 2 and the combustion engine 118 to be decoupled, respectively, from the generator 108. A controller 132 is connected with the clutches to control which of the turbine and engine are connected with the generator. With this configuration, either the wind turbine or the combustion engine drives the generator. Also, both the turbine and engine can drive the generator at the same time.

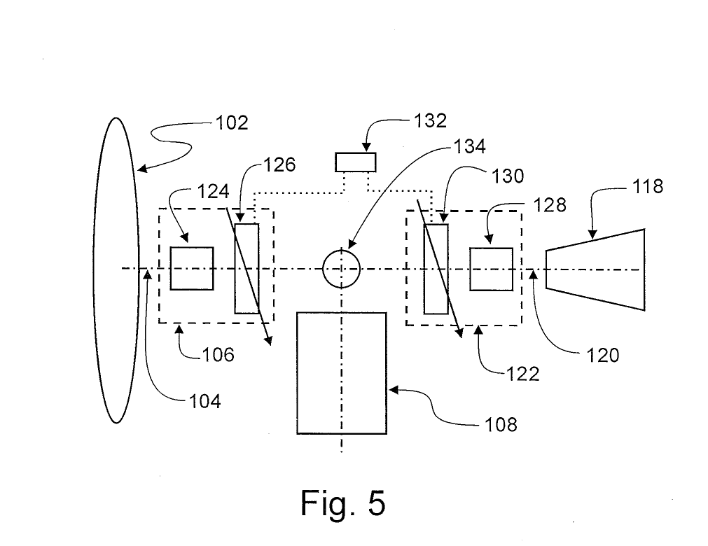

A more complex but potentially more useful embodiment is illustrated in FIG. 5. The wind turbine and the combustion engine have the same drive trains as in the embodiment of FIG. 4, but the drive trains are connected through a differential 134. The differential is similar to an automobile differential operated in reverse. In an automobile, a differential allows the engine to drive two wheels at different speeds but at the same torque. In the hybrid power generator according to the invention, two engines (wind turbine and combustion engine) are provided, each operating at a different speed, to drive a single generator at the same time.

The hybrid wind turbine/engine power generator according to the invention can be operated in four different modes. The first mode uses only the wind turbine. The combustion engine is disconnected via the clutch 130 and the hybrid functions as a traditional wind turbine generator. Since this mode of operation consumes no fuel, it is the lowest cost operating mode and would be the preferred operating mode when wind is blowing to drive the wind turbine. The second mode uses only the combustion engine. The clutch 126 disconnects the wind turbine from the generator and the combustion engine drives the same. In this mode, the hybrid generator functions as a traditional peak load generator. Since the fixed cost is lower than conventional peaking generators, operator margins should be greater. The third mode of operation may be referred to as a stable power mode. The combustion engine compensates for short term fluctuations in wind speed and wind turbine power. In this mode, both the wind turbine and the combustion engine simultaneously drive the generator. Combustion engine power is adjusted by its throttle so that the hybrid power generator produces a constant or slowly varying power output. This may be full rated capacity or some fraction thereof. The fourth mode of operation is under maximum wind conversion efficiency. Both the wind turbine and the engine simultaneously drive the generator. Wind turbines are normally designed to be most efficient at a 30 knot wind speed. They are less efficient at lower wind speeds. The output from the combustion engine can be adjusted so that for any given wind speed, the wind turbine blades are allowed to rotate at a speed that optimizes lift to drag ratio. Controlling the wind turbine blade rotation rate introduces another operating variable that enables hybrid wind turbine/engine power generators to have higher wind turbine efficiencies.

While the preferred forms and embodiments of the invention have been illustrated and described, it will become apparent to those of ordinary skill in the art that various changes and modifications may be made without deviating from the inventive concepts set forth above.

What is claimed is:

1. A hybrid electric power generator, comprising
(a) a generator having a rotary power input and an electric power output;
(b) a wind turbine connected with said generator input for providing rotary power to said input in response to wind impinging on said turbine; and
(c) a combustion engine connected with said generator input for providing rotary power to said input when said engine is operating, whereby the electric power output from said generator may be connected with an electric grid for distribution of electricity to consumers.

2. A hybrid electric power generator as defined in claim 1, and further comprising a first drive train connected between said wind turbine and said generator and a second drive train connected between said combustion engine and said generator to match the output from said wind turbine and said combustion engine, respectively, with the rotary power input of said generator.

3. A hybrid electric power generator as defined in claim 2, wherein said first and second drive trains comprise a single assembly connecting said wind turbine and said combustion engine with said generator.

4. A hybrid electric power generator as defined in claim 2, where each of said drive trains comprises a gearbox and a clutch connected therewith.

5. A hybrid electric power generator as defined in claim 4, wherein said clutches are operable to disengage one of said turbine and said combustion engine from said generator.

6. A hybrid electric power generator as defined in claim 2, and further comprising a differential connecting said drive trains with said generator.

7. A hybrid electric power generator as defined in claim 4, and further comprising a converter connected with the output of said generator to convert the electric power output from said generator to match that of an electric power grid.
